(19) United States
(12) Patent Application Publication
(10) Pub. No.: US 2016/0327035 A1
(43) Pub. Date: Nov. 10, 2016

(54) HIGH-EFFICIENCY COLOR-PASTE COLOR-MIXING PUMP

(71) Applicant: Zhengzhou Sanhua Technology & Industry Co., Ltd., Zhengzhou, Henan (CN)

(72) Inventors: Ruhua SHEN, Zhengzhou, Henan (CN); Huan LI, Zhengzhou, Henan (CN); Weidan XUE, Zhengzhou, Henan (CN)

(21) Appl. No.: 15/112,102

(22) PCT Filed: Jan. 12, 2015
(86) PCT No.: PCT/CN2015/070531

§ 371 Date: Jul. 15, 2016

(30) Foreign Application Priority Data
Jan. 17, 2014 (CN) 201410021839.3

(51) Int. Cl. F04B 53/02; B44D 3/08; F04B 53/18; F04B 1/12; F04B 1/14

(52) U.S. Cl. CPC F04B 53/02; F04B 1/124; F04B 1/148; F04B 1/143; F04B 53/18; B44D 3/08

(57) ABSTRACT

In order to solve the problem of great abrasion of pistons and cylinder bores of a high-efficiency color-paste color-mixing pump, the invention provides a high-efficiency color-paste color-mixing pump with little abrasion of plunger pistons and cylinder bores, comprising cylinder bodies arranged around the circumference of a shaft and the plunger pistons matched with the cylinder bodies, wherein the cylinder bodies and the plunger pistons are sealed in a swelling, hard and fitted manner, that is, sealing elements between the cylinder bodies and the plunger pistons are sealing elements swelling towards the plunger pistons, and contact parts between the plunger pistons and the sealing elements are made of a hard material. Because in the high-efficiency color-paste color-mixing pump, a rolling friction pair of a roller and a swash-plate is used which is an improvement over a sliding friction pair of a slipper and a swash-plate of a swash-plate axial plunger piston pump, the friction force is greatly reduced, and thus the rolling friction force of the roller and the swash-plate of the high-efficiency color-paste color-mixing pump has very little impact on stress of the plunger pistons; and in addition, the roller and the swash-plate adopt the rolling friction pair, the stress of the plunger pistons is relatively simple, and the abradability of the contact parts between the plunger pistons and the sealing elements can be increased by increasing the hardness.

### FIELD OF THE INVENTION

The invention belongs to the field of full-automatic color-mixing machines and specifically relates to a high-efficiency color-mixing pump in a full-automatic color-mixing machine.

### BACKGROUND OF THE INVENTION

A full-automatic color-mixing machine is generally composed of a computer mainframe, a display device, color-mixing software and a color-mixing machine. Full-automation is relative to traditional manual color mixing, because the operation steps of a manual color-mixing machine are generally firstly pulling a pump body to a certain height by hand and then opening a valve to inject color-paste into a basic paint bucket, while in the full-automatic color-mixing machine, the color-mixing machine is controlled by color-mixing software which is preloaded into a computer to execute various actions to achieve the purpose of precisely injecting the color-paste into coating. By using the full-automatic color-mixing machine, the advantages of saving time, saving trouble, being less prone to errors and being capable of realizing a very high precision are realized. The full-automatic color-mixing machines, full-automatic shocking machines, full-automatic rotating machines and other paint blending equipment together constitute a mainstream store color-mixing system. At present, the high-end automatic color-mixing machines are mainly produced by developed countries, but domestic brands have obtained a huge success in the field of coating blending machines and manual color-mixing machines by relying on a relatively stable quality and low price, and high-end full-automatic computer color-mixing machines are being researched and developed. The inventive patent application with the Patent No. 201210180754.0 and entitled “Color-Paste Quantitative Supply Device of Color-Mixing Machine” is a high-efficiency color-paste color-mixing pump designed by utilizing the principle of a swash-plate axial plunger piston pump. As color-mixing color-paste is relatively sensitive to contamination of hydraulic oil, an improvement is made, based on the high-efficiency color-mixing pump, in a friction pair of the swash-plate axial plunger piston pump, such that a rolling friction pair of a roller and the swash-plate is formed by improvement on the sliding friction pair of a slipper and a swash-plate. With the consideration that plunger pistons of the swash-plate axial plunger piston pump are subject to a complex resultant force in an axial direction, a radial direction, a rotating direction, etc., hardening and tempering are performed when heat treatment is performed on the plunger pistons, to achieve suitable matching of a high strength and high toughness; this heat treatment way can be used by lubricating with an oil film and be directly used on the high-efficiency color-mixing pump for dry friction, then the abrasion of the plunger pistons is excessive, the service life is very short, and the plunger pistons can not be used normally, so that an oil film lubrication friction pair enabling the plunger pistons of the swash-plate axial plunger piston pump to match with cylinder bores is improved to form a dry friction pair enabling pistons to match with the cylinder bores. However, the dry friction pair enabling the pistons to match with the cylinder bores causes a relatively great abrasion of the pistons for the color-paste containing mineral dyes, such as iron oxide red and iron oxide yellow, and cannot meet the technical requirements of repeatedly and normally working 1.55 million times, producing 10,000 liters of the color-paste and realizing the service life of 5 years.

### SUMMARY OF THE INVENTION

In order to solve the problem of great abrasion of pistons and cylinder bores of a high-efficiency color-paste color-mixing pump, the invention provides a high-efficiency color-paste color-mixing pump with little abrasion of plunger pistons and cylinder bores, which is specifically as follows:

The high-efficiency color-paste color-mixing pump comprises cylinder bodies arranged around the circumference of a shaft and plunger pistons matched with the cylinder bodies, wherein the cylinder bodies and the plunger pistons are sealed in a swelling, hard and fitted manner, that is, sealing elements between the cylinder bodies and the plunger pistons are sealing elements swelling towards the plunger pistons, and the parts on the plunger pistons, which are in contact with the sealing elements, are made of a hard material.

The parts on the plunger pistons, which are in contact with the sealing elements, are made of a hard material, and the whole plunger pistons or the entire surfaces of the plunger pistons are made of a hard material.

The situation that the parts on the plunger pistons, which are in contact with the sealing elements, are made of a hard material is limited to the situation that an annular hard material is arranged on the contact parts between the plunger pistons and the sealing elements.

The situation that an annular hard material is arranged on the contact parts is that a hard material is fixedly embedded and sleeved on the plunger pistons or a hard material is coated on the plunger pistons.

The hard material is one of nitrided metal, ion soft-nitrided metal, hard metal material, ceramic material and glass material.

The nitrided metal is a hard material which is formed by surface carburizing and quenching of GCr15 and has a hardness of more than HRC55.

The swelling, hard and fitted sealing refers to that two sealing elements swelling towards the plunger piston are arranged along the axial direction of the plunger piston in series so that the distance between the two sealing elements is more than or equal to the stroke of the plunger piston.

A gap between the two sealing elements is filled with a lubricating material.

The lubricating material is lubricating grease.

The sealing elements swelling towards the plunger pistons are O-rings, corrugated pipes, wedge-shaped rings or spring seals.

The spring seals are spring seals added with packing.

The packing is carbon fiber or glass fiber.

The plunger pistons which are formed by surface carburizing and quenching of GCr15 and have a hardness of more than HRC55.

Spring side surfaces of the spring seals, which exert pressure onto the plunger pistons, are continuous surfaces.

The spring side surfaces which exert the pressure onto the plunger pistons are continuous surfaces, and springs involved are one of metal corrugated pipes, metal annular expansion pipes, spring hoops, reticular ring expansion pipes or spiral spring rings.

Because in the high-efficiency color-paste color-mixing pump, a rolling friction pair of a roller and the swash-plate is adopted which is an improvement over a sliding friction pair of a slipper and a swash-plate of a swash-plate axial plunger piston pump, and the rolling friction force is much less than the sliding friction force, the rolling friction force of the roller and the swash-plate of the high-efficiency color-paste color-mixing pump has very little impact on stress of the plunger pistons. The patent adopts the rolling friction pair of the roller and the swash-plate, so that the stress of the plunger pistons of the patent is relatively simple, and the abrasion of the contact parts between the plunger pistons and the sealing elements can be increased by increasing the hardness; and multiple experiments prove that, as long as the hardness is larger than the hardness of the plunger pistons which are subject to hardening and tempering treatment, the abrasion resistance performance can be enhanced, and the specific abrasion resistance degree depends on the performance-price ratio.

### BRIEF DESCRIPTION OF THE DRAWINGS

FIG. 1 illustrates a structural schematic diagram of a plunger piston pump part using O-rings as sealing elements in the invention.

FIG. 2 is an enlarged schematic diagram of part A1 in FIG. 1.

FIG. 3 illustrates a structural schematic diagram of a plunger piston pump part using corrugated pipes as sealing elements in the invention.

FIG. 4 is an enlarged schematic diagram of part A2 in FIG. 3.

FIG. 5 illustrates a structural schematic diagram of a plunger piston pump part using wedge-shaped rings as sealing elements.

FIG. 6 is an enlarged schematic diagram of part A3 in FIG. 5.

FIG. 7 illustrates a structural schematic diagram of a plunger piston pump part using metal corrugated pipe spring seals as sealing elements.

FIG. 8 is an enlarged schematic diagram of part A4 in FIG. 7.

FIG. 9 illustrates a structural schematic diagram of a plunger piston pump part using metal annular pipe spring seals as sealing elements.

FIG. 10 is an enlarged schematic diagram of part AS in FIG. 9.

FIG. 11 illustrates a structural schematic diagram of a plunger piston pump part using spring hoop spring seals as sealing elements.

FIG. 12 is an enlarged schematic diagram of part A6 in FIG. 11.

FIG. 13 is a structural schematic diagram of a spring hoop.

FIG. 14 illustrates a structural schematic diagram of a plunger piston pump part using reticular annular expansion pipe spring seals as sealing elements.

FIG. 15 is an enlarged schematic diagram of part A7 in FIG. 14.

FIG. 16 is a structural schematic diagram of a reticular annular expansion pipe.

FIG. 17 illustrates a structural schematic diagram of a plunger piston pump part using spiral spring ring spring seals as sealing elements.

FIG. 18 is an enlarged schematic diagram of part A8 in FIG. 17.

FIG. 19 is a structural schematic diagram of a plunger piston.

FIG. 20 is a schematic diagram of a plunger piston section structure with coating hard material.

FIG. 21 is an enlarged schematic diagram of part B1 in FIG. 20.

FIG. 22 is a schematic diagram of a plunger piston section structure with a fixed inlay sleeve.

FIG. 23 is an enlarged schematic diagram of part B2 in FIG. 22.

Symbols in drawings: 1: cylinder body; 2: plunger piston; 3: coating hard material; 31: fixed inlay sleeve; 4: O-seal ring; 5-corrugated pipe; 6: wedge-shaped ring; 7: spring seal; 8: metal corrugated pipe; 9: metal annular expansion pipe; 10: spring hoop; 11: reticular annular expansion pipe; 12: spiral spring ring; 13: support sleeve; 14: sealing seat.

### DETAILED DESCRIPTION OF THE EMBODIMENTS

The following description and accompanying drawings illustrate the exemplary schemes of the invention. The accompanying drawings are schematic diagrams and only clearly show the parts which are related to the invention. Those of skill in the art can understand the structures and the connection relations of the parts which are not shown according to the description and the accompanying drawings.

The specific structure of the invention is described below according to the accompanying drawings of the invention. A high-efficiency color-paste color-mixing pump comprises cylinder bodies 1 arranged around the circumference of a shaft and plunger pistons 2 matched with the cylinder bodies 1, wherein the cylinder bodies 1 and the plunger pistons 2 are sealed in a swelling, hard and fitted manner, that is, sealing elements between the cylinder bodies 1 and the plunger pistons 2 are sealing elements swelling towards the plunger pistons 2, and contact parts between the plunger pistons 2 and the sealing elements are made of a hard material.

The hardness of the hard material is greater than the hardness of the plunger pistons which are subject to hardening and tempering treatment. As long as the hardness of the plunger pistons is greater than the hardness of the hardening and tempering treatment, the abrasion resistance performance can be enhanced. The condition is that sealing elements swelling towards the plunger pistons 2 are in mechanical contact and sealing.

The parts on the plunger pistons 2, which are in contact with the sealing elements, are made of a hard material, and the whole plunger pistons 2 or the entire surfaces of the plunger pistons 2 are made of a hard material. Thus, the whole plunger pistons are made of abrasion-resistant material, or the entire surfaces of the plunger pistons are subject to hardening treatment, and the surfaces can be subject to spraying, electroplating, heat treatment, etc. for hardening so as to realize abrasion resistance.

The situation that the parts on the plunger pistons 2, which are in contact with the sealing elements, are made of a hard material is limited to the situation that an annular hard material is arranged on the contact parts between the plunger pistons and the sealing elements.

The situation that an annular hard material is arranged on the parts on the plunger pistons 2, which are in contact with the sealing elements, can be that the hard material is annularly arranged on the plunger pistons 2. In this case, plunger piston rods can be subject to hardening and tempering treatment. When the coating hard material 3 has high price, the using amount of the coating hard material can be reduced and the cost can be reduced.

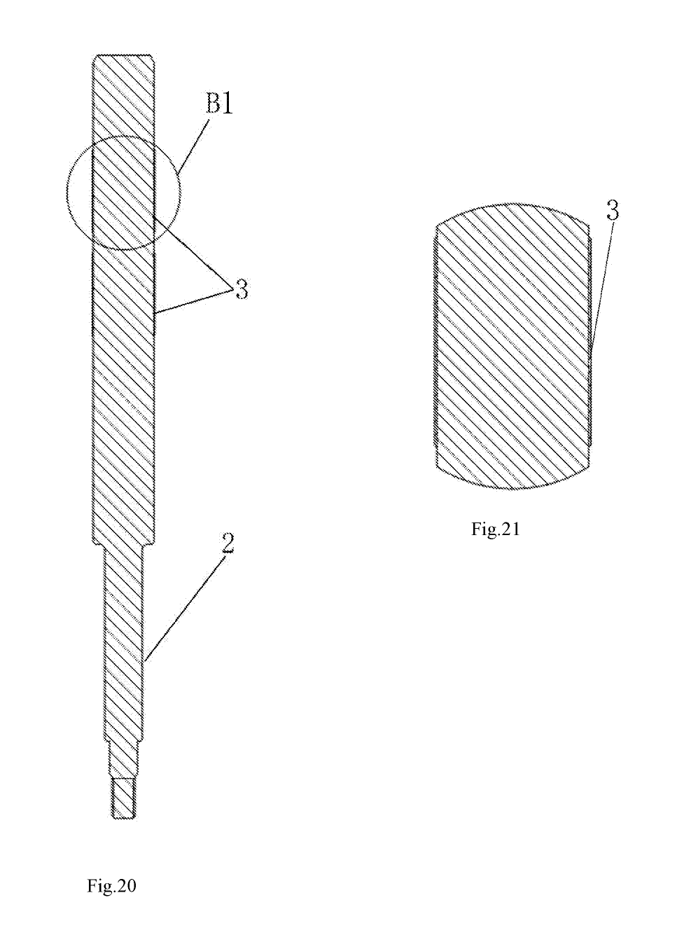

The situation that the hard material is annularly arranged on the plunger pistons 2 can be that the hard material 3 is coated on the plunger pistons, as shown in the FIGS. 20-21, the hard material in the drawings stick out of the surfaces of the plunger pistons 2. However, by electroplating or performing heat treatment on the surfaces of the plunger pistons 2 of the parts, it actually can not or is not easy to show protrusion; and the coating hard material 3 can be coated on the plunger pistons 2 by spraying, electroplating, welding or other existing way to realize the contact between the coating hard material 3 and the sealing elements, achieve the coordination of high strength and high toughness and enhance the abrasion resistance.

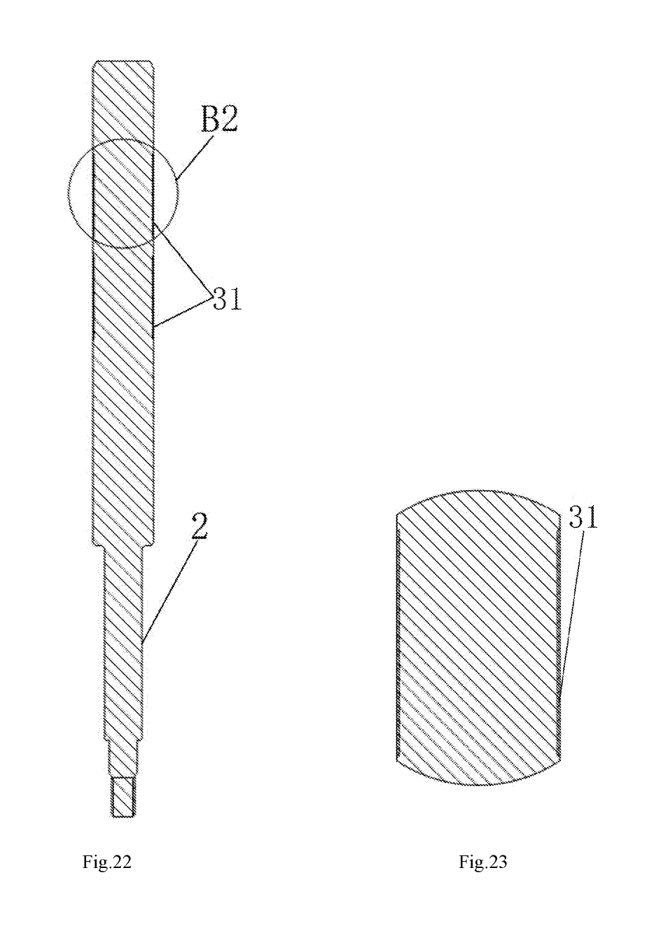

The situation that an annular hard material is arranged on the contact parts between the plunger pistons 2 and the sealing elements can also be the situation that the hard material 31 is fixedly embedded and sleeved on the plunger pistons 2. As shown in FIGS. 22-23, the hard material in the drawings is arranged in an annular groove of the plunger piston 2, the outer diameter of the hard material is the same with that of the plunger piston, then the plunger piston rod inserting into the cylinder bore part is cylindrical so as to be conductive to positioning the plunger piston 2, this is not the sole way. Actually, the outer diameter of the hard material can be slightly larger than or smaller than the outer diameter of the plunger piston, and then the invention can also be realized; and there are many ways to embed and sleeve the pipy material in the annular groove of the plunger piston, and the existing ways can be used for sleeving. Thus, the plunger piston rod inserting into the cylinder bore part is cylindrical so as to be conductive to positioning the plunger piston 2.

The hard material can be nitrided metal, ion soft-nitrided metal, hard metal material, ceramic material, glass material and the like. Of course, cubic boron nitride and other ultrahard material can also be used.

The nitrided metal can be a hard material which is formed by surface carburizing and quenching of GCr15 and has a hardness of more than HRC55. This way has high performance-price ratio.

The swelling, hard and fitted sealing refers to that two sealing elements swelling towards the plunger piston 2 are arranged along the axial direction of the plunger piston 2 in series so that the distance between the two sealing elements is more than or equal to the stroke of the plunger piston 2. In such a way, the leakage is avoided, as the other sealing element can not realize repeated contact at the part where one sealing element is in contact with the plunger piston 2, then the repeated friction is avoided and the friction is reduced.

A gap between the two sealing elements is filled with a lubricating material. Then, the gap between the two sealing elements is used as a closed container for storing the lubricating material. The lubricating material is lubricating grease. The lubricating grease is commonly known as lubricating butter, and a very small amount of butter can not contaminate color-mixing color-paste, so that the contamination of the color-mixing color-paste is avoided.

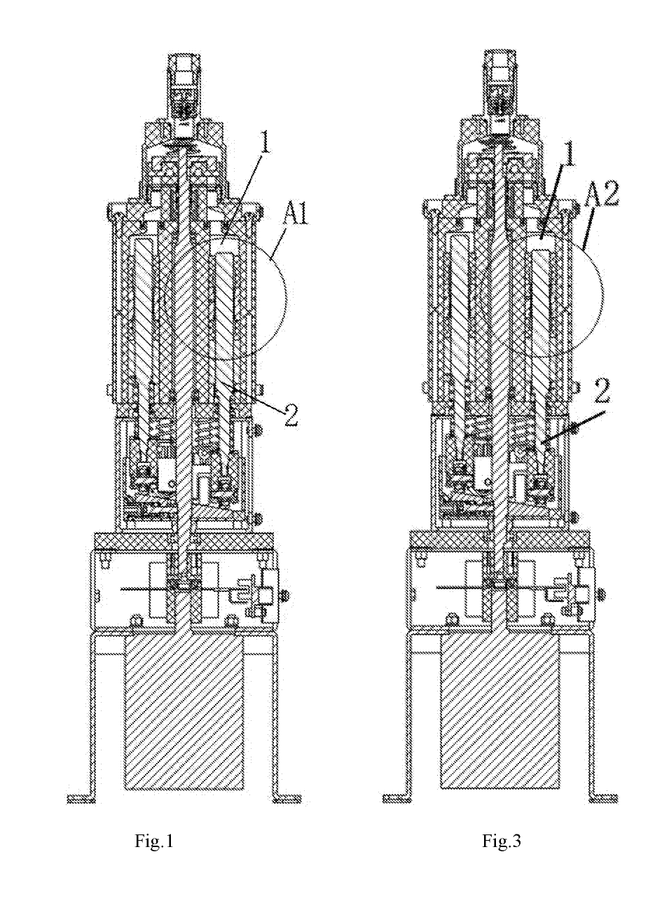

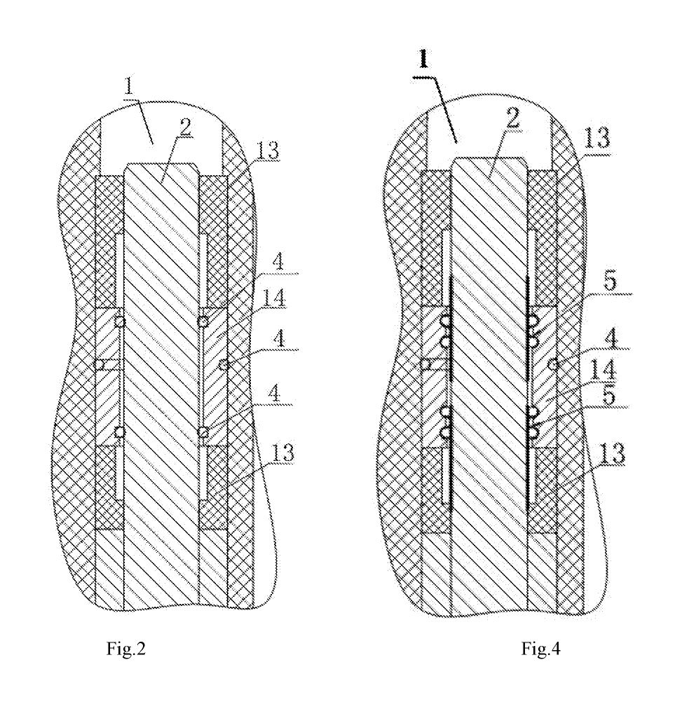

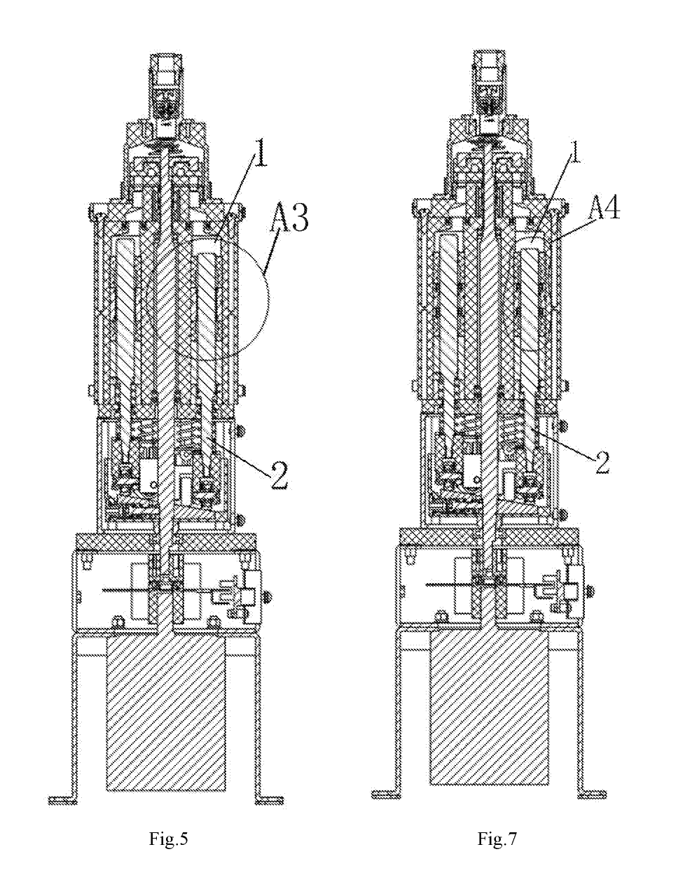

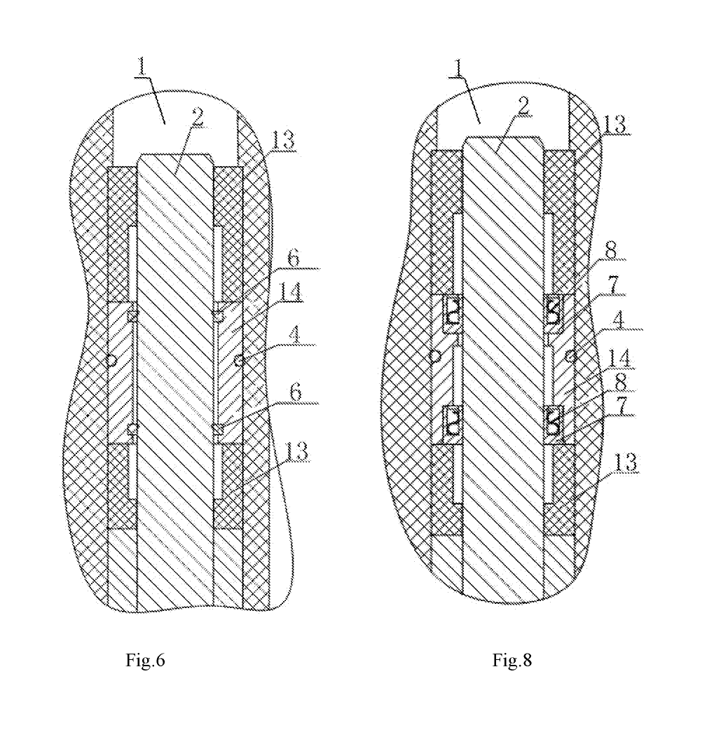

The sealing elements swelling towards the plunger pistons 2 can be O-rings 4 (FIGS. 1 and 2), corrugated pipes 5 (FIGS. 3 and 4) and wedge-shaped rings 6 (FIGS. 5 and 6).

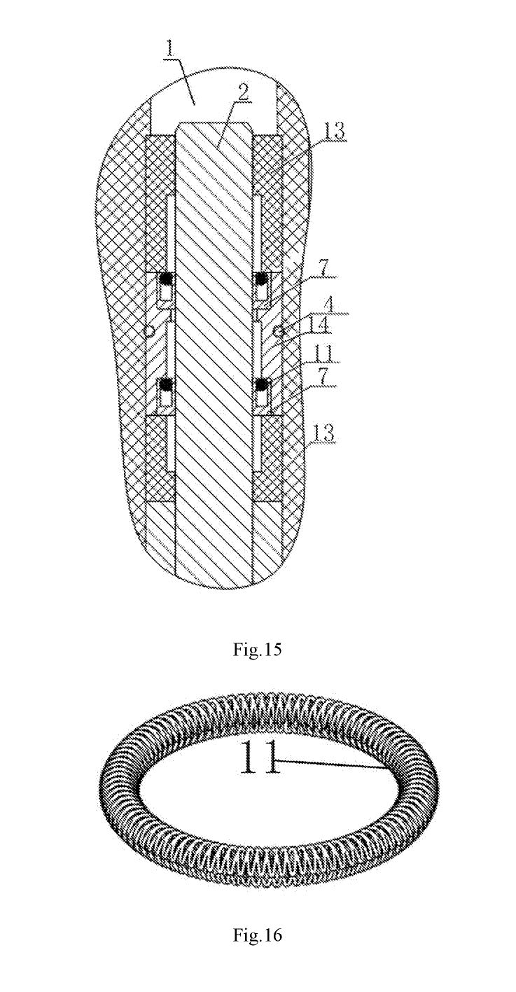

The sealing elements swelling towards the plunger pistons 2 can also be as shown in FIGS. 7-12, 14-15, and 17-18, and the sealing elements are spring seals 7; the spring seals 7 are spring seals added with packing, and the used packing is carbon fiber or glass fiber, the carbon fiber or the glass fiber is added in U-shaped sealing shape material for accommodating springs, the U-shaped sealing shape material for accommodating the springs is polytetrafluoroethylene material generally, and of course, other materials can be used.

The plunger pistons 2 are formed by surface carburizing and quenching of GCr15 and have a hardness of more than HRC55. Therefore, the high-efficiency color-mixing pump with 6 plunger pistons 2 which are arranged in such a way can ensure that the high-efficiency color-mixing pump can work repeatedly and normally 1.55 million times, produce 10,000 liters of the color-paste and realize the service life of 5 years, and this way is the way with relatively high performance-price ratio.

The spring side surfaces of the spring seals 7, which exert pressure onto the plunger pistons 2, are continuous surfaces, so that the situation that original tooth-shaped springs produce grooves in the plunger pistons by friction through lip sides is avoided.

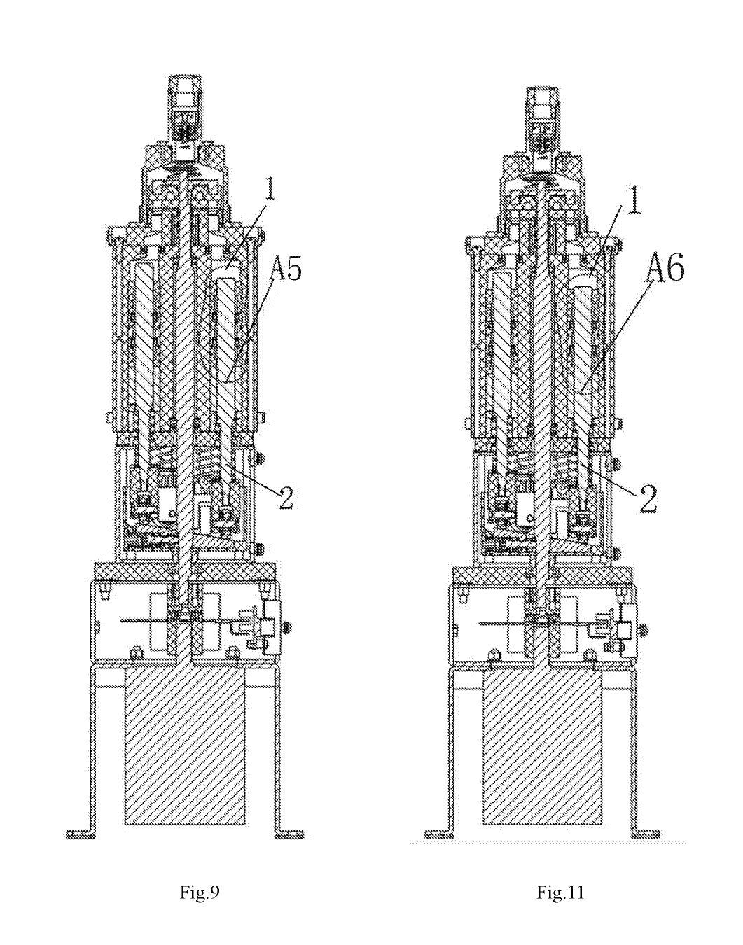

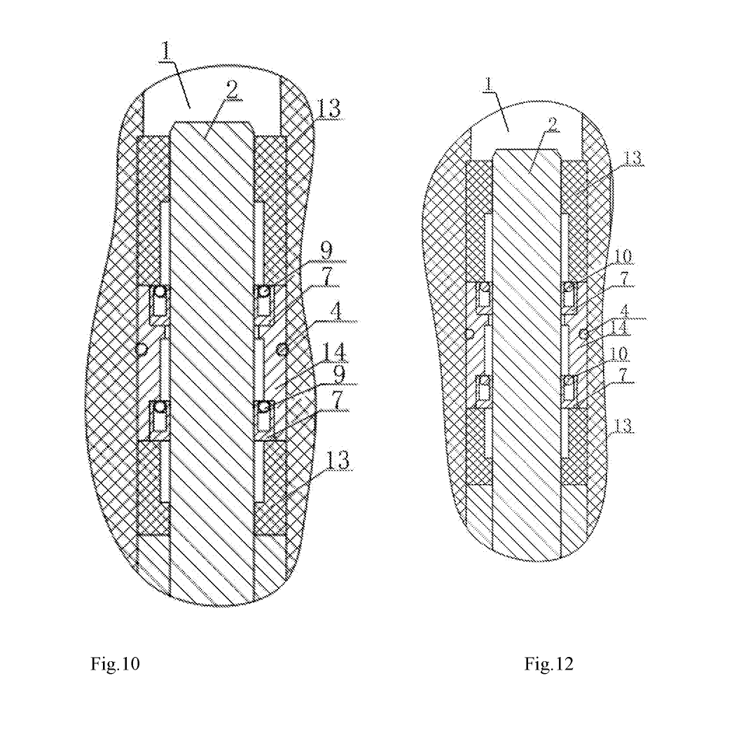

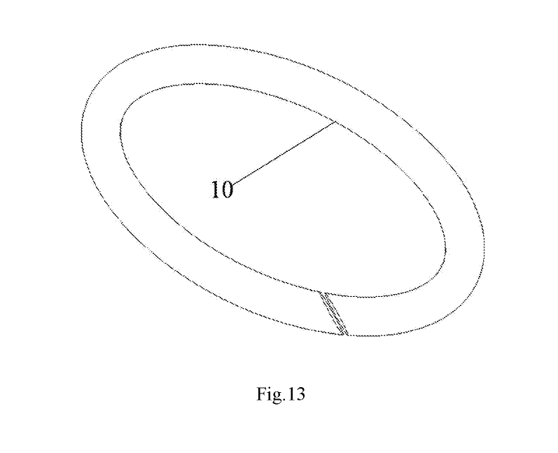

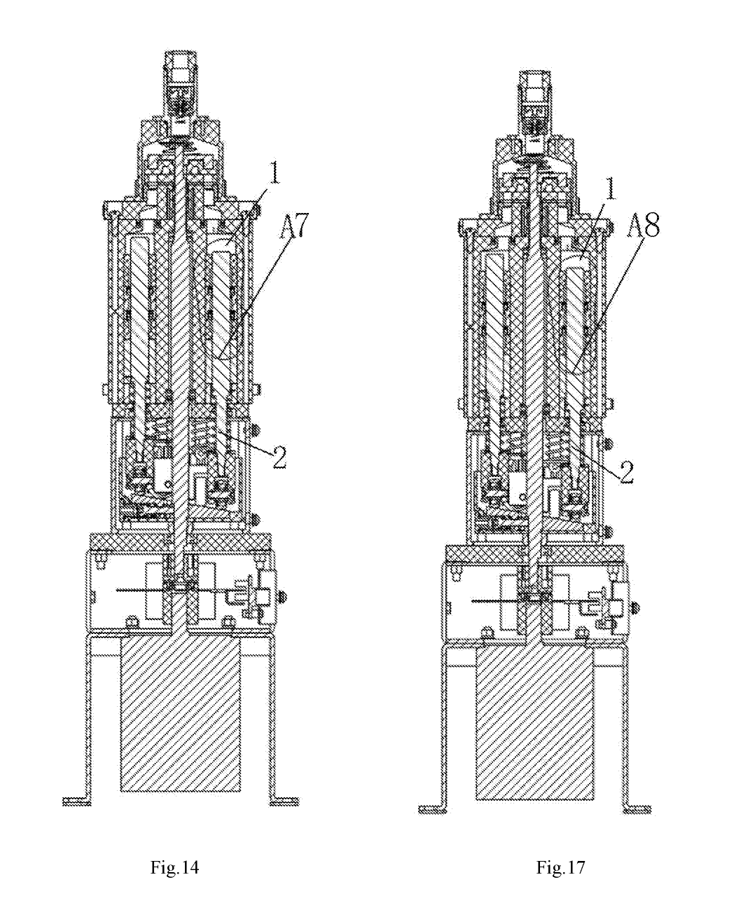

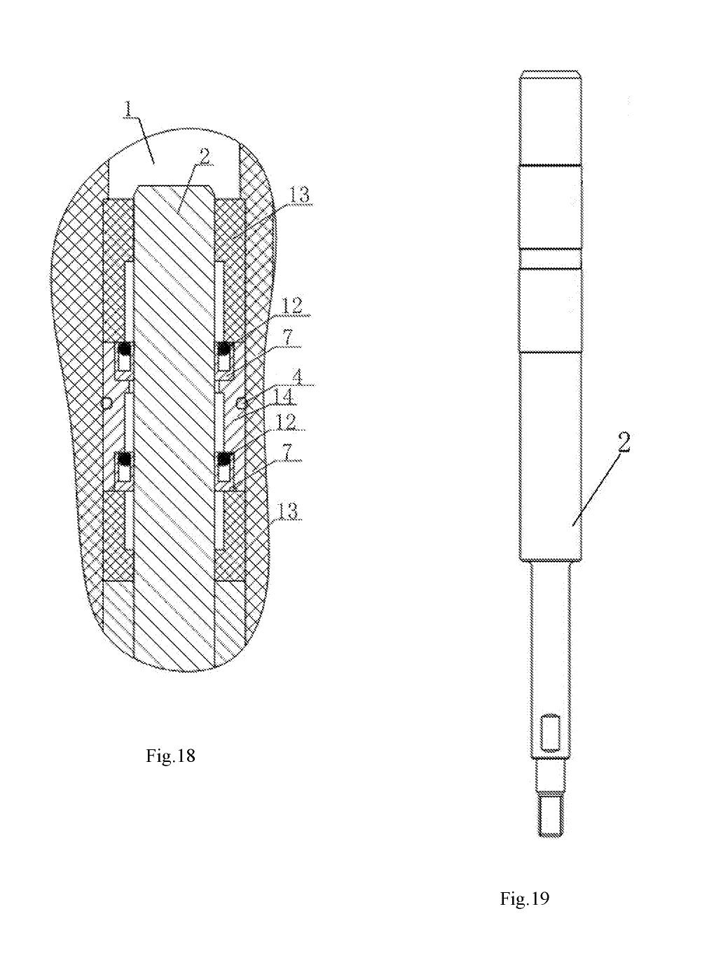

The spring side surfaces which exert the pressure onto the plunger pistons 2 are continuous surfaces, and springs here can be metal corrugated pipes 8 (FIGS. 7 and 8), metal annular expansion pipes 9 (FIGS. 9 and 10), spring hoops 10 (FIGS. 11-13), reticular ring expansion pipes 11 (FIGS. 14-16) or spiral spring rings 12 (FIGS. 17-18). Thus, as the pipe walls of the metal corrugated pipes 8 (FIGS. 7 and 8) and metal annular expansion pipes 9 are very thin, the elastic sealing principle is the same with that of the corrugated pipes. Steel wires of the spiral spring rings 12 and the reticular ring expansion pipes 11 are relatively thin, and the spiral diameter or the diameter of the expansion pipes can be changed to basically form the continuous surfaces.

The embodiments of the invention are not exhaustive and are only illustrative. The combinations of the parts of the technical features in other ways for reducing the friction between the plunger pistons and the sealing elements also belong to the embodiments of the invention.

1. A high-efficiency color-paste color-mixing pump, comprising cylinder bodies arranged around the circumference of a shaft and plunger pistons matched with the cylinder bodies, wherein the cylinder bodies and the plunger pistons are sealed in a swelling, hard and fitted manner, that is, sealing elements between the cylinder bodies and the plunger pistons are sealing elements swelling towards the plunger pistons, and contact parts between the plunger pistons and the sealing elements are made of a hard material.

2. The high-efficiency color-paste color-mixing pump according to claim 1, wherein in that the parts on the plunger pistons, which are in contact with the sealing elements, are made of a hard material, and the whole plunger pistons or the entire surfaces of the plunger pistons are made of a hard material.

3. The high-efficiency color-paste color-mixing pump according to claim 1, wherein in that the situation that the parts on the plunger pistons, which are in contact with the sealing elements, are made of a hard material is limited to the situation that an annular hard material is arranged on the contact parts between the plunger pistons and the sealing elements.

4. The high-efficiency color-paste color-mixing pump according to claim 3, wherein the situation that an annular hard material is arranged on the contact parts is that the hard material is fixedly embedded and sleeved on the plunger pistons or the hard material is coated on the plunger pistons.

5. The high-efficiency color-paste color-mixing pump according to claim 1, wherein the hard material is one of nitrided metal, ion soft-nitrided metal, hard metal material, ceramic material and glass material.

6. The high-efficiency color-paste color-mixing pump according to claim 5, wherein the nitrided metal is a hard material which is formed by surface carburizing and quenching of GCr15 and has a hardness of more than HRC55.

7. The high-efficiency color-paste color-mixing pump according to claim 1, wherein the swelling, hard and fitted sealing refers to that two sealing elements swelling towards the plunger pistons are arranged along the axial direction of the plunger pistons in series so that the distance between the two sealing elements is more than or equal to the stroke of the plunger pistons.

8. The high-efficiency color-paste color-mixing pump according to claim 7, wherein a gap between the two sealing elements is filled with a lubricating material.

9. The high-efficiency color-paste color-mixing pump according to claim 8, wherein the lubricating material is lubricating grease.

10. The high-efficiency color-paste color-mixing pump according to claim 9, wherein the sealing elements swelling towards the plunger pistons are O-rings, corrugated pipes, wedge-shaped rings or spring seals.

11. The high-efficiency color-paste color-mixing pump according to claim 10, wherein the spring seals are spring seals added with packing.

12. The high-efficiency color-paste color-mixing pump according to claim 11, wherein the packing is carbon fiber or glass fiber.

13. The high-efficiency color-paste color-mixing pump according to claim 12, wherein the plunger pistons are plunger pistons which are formed by surface carburizing and quenching of GCr15 and have a hardness of more than HRC55.

14. The high-efficiency color-paste color-mixing pump according to claim 12, wherein spring side surfaces of the spring seals, which exert pressure onto the plunger pistons, are continuous surfaces.

15. The high-efficiency color-paste color-mixing pump according to claim 14, wherein the spring side surfaces which exert the pressure onto the plunger pistons are continuous surfaces, and springs involved are one of metal corrugated pipes, metal annular expansion pipes, spring hoops, reticular ring expansion pipes or spiral spring rings.
